(19) United States
(12) Patent Application Publication
(10) Pub. No.: US 2014/0168937 A1
(43) Pub. Date: Jun. 19, 2014

(54) LIGHTING DEVICE AND ELECTRONIC DEVICE

(71) Applicant: Fujitsu Limited, Kawasaki-shi (JP)

(72) Inventors: Ju KATO, Kawasaki (JP); Yasufumi YAMAMOTO, Kawasaki (JP); Eiji TAKIZAWA, Sagamihara (JP)

(73) Assignee: Fujitsu Limited, Kawasaki-shi (JP)

(21) Appl. No.: 14/091,628

(22) Filed: Nov. 27, 2013

(30) Foreign Application Priority Data
Dec. 14, 2012 (JP) 2012-273782

(51) Int. Cl. F21V 33/00; F21V 14/04; F21V 14/00

(52) U.S. Cl. CPC F21V 33/0052; F21V 14/00; F21V 14/04
USPC 362/23.03; 362/277; 362/235

(57) ABSTRACT

A lighting device includes a light source which is disposed in a vicinity of a part to be lighted and provided for a function other than lighting the part to be lighted, and a light projecting part which is movable between a lighting position and a non-lighting position and configured to emit the light from the light source to the part to be lighted when the light projecting part is moved to the lighting position.

### CROSS-REFERENCE TO RELATED APPLICATION

This application is based upon and claims the benefit of priority from the prior Japanese Patent Application No. 2012-273782 filed on Dec. 14, 2012, the entire contents of which are incorporated herein by reference.

### FIELD

The embodiment discussed herein is related to a device configured to light an input operation section of an electronic device.

### BACKGROUND

Sometimes, an electronic device such as a notebook computer is used in a dark environment. For example, when a notebook computer is used in an airplane, a user may perform an input operation of the keys of the notebook computer in a dark environment with low lighting in the airplane. In this case, it is desirable to light up only the keys, so that a user may recognize the keys of an operation section and other passengers are not bothered by the light.

Thus, a side lighting unit has been proposed in which light guiding material is disposed in the vicinity of an object to be lighted of an electronic device and an LED is disposed as a light source at one end of the light guiding material so that the object is irradiated with the light from the LED via the light guiding material. This technique is disclosed, for example, in International Publication Pamphlet No. WO 2007/097117. In addition, a technique has been proposed in which in an information processing device which is provided with an LCD having a backlight in the vicinity of an operation section (keyboard), light from the backlight is guided by a light guiding unit and an operation section is lighted from a diagonally upper position. This technique is disclosed, for example, in Japanese Laid-Open Patent Publication No. 2001-67145.

### SUMMARY

According to an aspect of the invention, a lighting device includes a light source which is disposed in a vicinity of a part to be lighted and provided for a function other than lighting the part to be lighted, and a light projecting part which is movable between a lighting position and a non-lighting position and configured to emit the light from the light source to the part to be lighted when the light projecting part is moved to the lighting position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view of an electronic device provided with a lighting device according to an embodiment;

FIG. 2 is an enlarged view of portion A illustrated in FIG. 1;

FIG. 3 is a view illustrating a state in which a power button is projecting upward;

FIG. 4 is a top view of the main body of a notebook computer;

FIG. 5 is an enlarged cross-sectional view taken along line V-V in FIG. 4;

FIG. 6 is an enlarged cross-sectional view taken along line VI-VI in FIG. 4;

FIG. 7 is a perspective view of the power button;

FIG. 8 is a perspective view of the power button with a transparent part removed;

FIG. 9 is a perspective view from below of the power button with the transparent part removed;

FIG. 10 is a top view of the main body with the power button at a raised position;

FIG. 11 is an enlarged cross-sectional view taken along line XI-XI in FIG. 10;

FIG. 12 is an enlarged cross-sectional view taken along line XII-XII in FIG. 10;

FIG. 13 is a cross-sectional view in the case where a coil spring is used as an elastic body;

FIG. 14 is an enlarged view of portion B in FIG. 1;

FIG. 15 is a cross-sectional view taken along line XV-XV in FIG. 14;

FIG. 16 is a perspective view illustrating a reflective plate which is raised;

FIG. 17 is a cross-sectional view taken along line XVII-XVII in FIG. 16; and

FIG. 18 is a top view of the main body of the notebook computer, the view illustrating an irradiation range of the light projecting from the reflective plate.

### DESCRIPTION OF EMBODIMENTS

Providing an additional light source for lighting and light guiding material for guiding the light from the light source as disclosed in International Publication Pamphlet No. WO 2007/097117 hinders miniaturization and thinning of the electronic device. In addition, the number of components of the electronic device and manufacturing cost are increased.

As disclosed in Japanese Laid-Open Patent Publication No. 2001-67145, a light guiding unit for guiding light from a back light of a display device to a keyboard has a complicated structure, and thus miniaturization and thinning of the information processing device may be hindered. Furthermore, because the additional light guiding unit is provided, the manufacturing cost of the information processing device is increased accordingly.

Then, in order to solve the above-described problem, it is desirable to develop a lighting device without providing therein an additional light source or a complicated light guiding unit, the lighting device being capable of lighting up an operation section.

Next, an embodiment will be described with reference to the drawings.

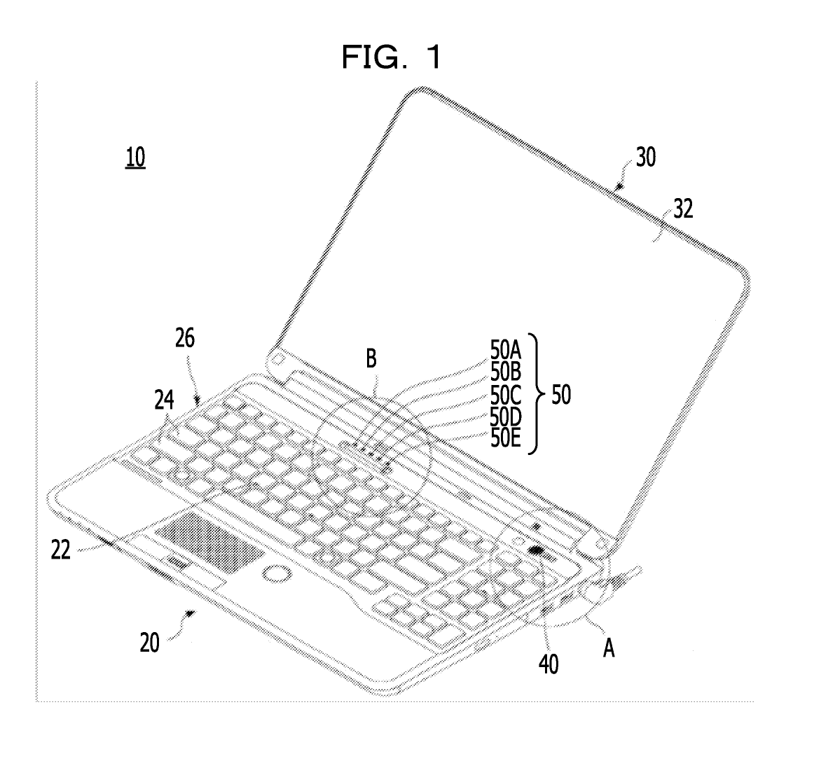

FIG. 1 is a perspective view of an electronic device provided with a lighting device according to an embodiment. FIG. 1 illustrates a notebook computer as an example of an electronic device provided with the lighting device. An electronic device provided with the lighting device according to the present embodiment is not limited to a notebook computer. For example, a lighting device according to the present embodiment may be applied to a device having an operation section such as a keyboard of a desktop PC.

A notebook computer 10 illustrated in FIG. 1 includes a main body 20 having an input operation section 26 on which alphabet keys 22 and various function keys 24 are arranged, and a display section 30 having a display device 32 such as an LCD. One side of the display section 30 is mounted on one side of the main body 20, and the display section 30 may be rotated with respect to the main body 20.

In the main body 20, a power button 40 and indicators 50A to 50E are arranged in the vicinity of the input operation section 26.

The power button 40 is a switch button for turning on or off the power supply of the notebook computer 10. The power button 40 is a component which is operated by an operator pressing with a finger and has a certain size so as to be easily pressed with a finger.

The indicators 50A to 50E are display lights which each display an operation state of the notebook computer 10. The indicators 50A to 50E light on to indicate ON/OFF states of various operations and functions.

In the present embodiment, various keys of the input operation section 26 are lighted up by using a light source for lighting up the power button 40 from the inside. In addition, the various keys of the input operation section 26 are lighted up by using a light source for lighting the indicators 50A to 50E.

First, a lighting device will be described which lights up the keys 22, 24 of the input operation section 26 by using the light source for lighting up the power button 40 from the inside. The input operation section 26 including the various keys 22, 24 is a part to be lighted and corresponds to a to-be-lighted part.

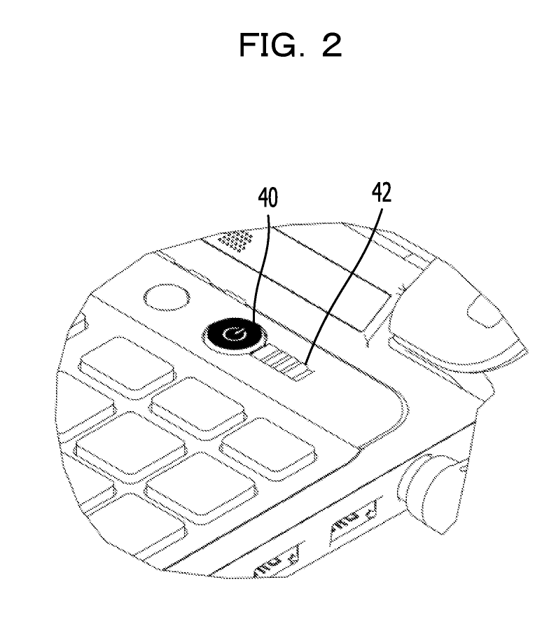

FIG. 2 is an enlarged view of portion A illustrated in FIG. 1. The power button 40 is a button which may pop up as described below. FIGS. 1 and 2 illustrate a state in which the power button 40 is pressed down and fixed by a slide knob 42.

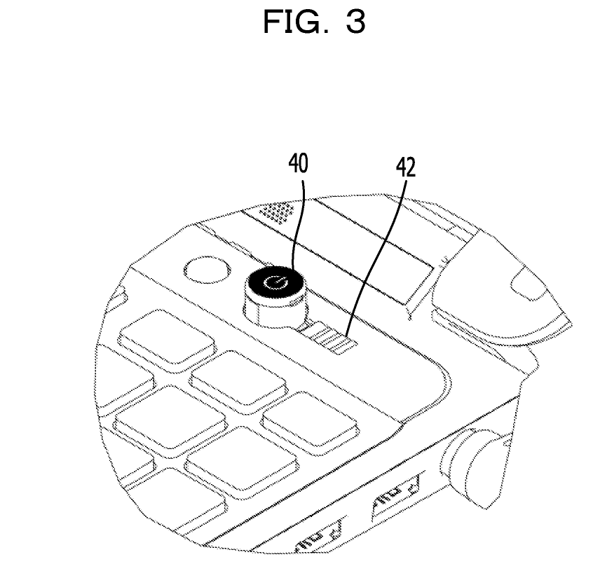

FIG. 3 is a view illustrating a state in which the power button 40 is raised up. In the present embodiment, the power button 40 is raised as illustrated in FIG. 3, thus light is emitted to the keys 22, 24 from the side of the power button 40, so that the keys 22, 24 may be lighted up.

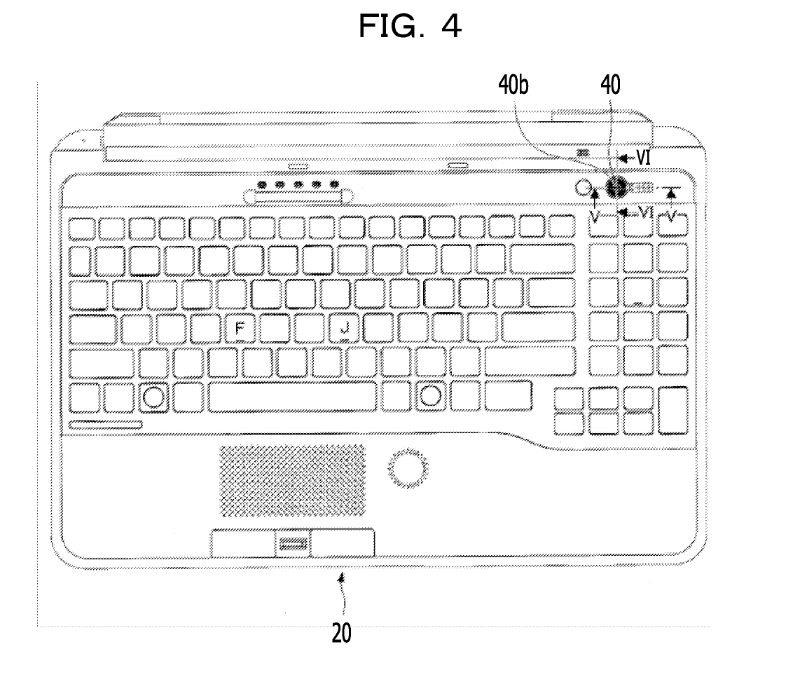

FIG. 4 is a top view of the main body 20 of the notebook computer 10. The power button 40 is provided in the vicinity of the input operation section 26 on which the alphabet keys 22 and the various function keys 24 are arranged. The power button 40 is a cylindrical member having a top surface 40a which is provided with an icon 40b indicating a power switch. As described below, a light source is provided below the power button 40 and light from the light source is emitted to the icon 40b from the inside of the power button 40. The icon 40b is formed as a pattern of a transparent portion, and light, which has emitted from the inside of the power button 40, passes through the icon 40b and emits to the outside of the power button 40. Thus, the icon 40b lights up and the visibility of the power button 40 is improved.

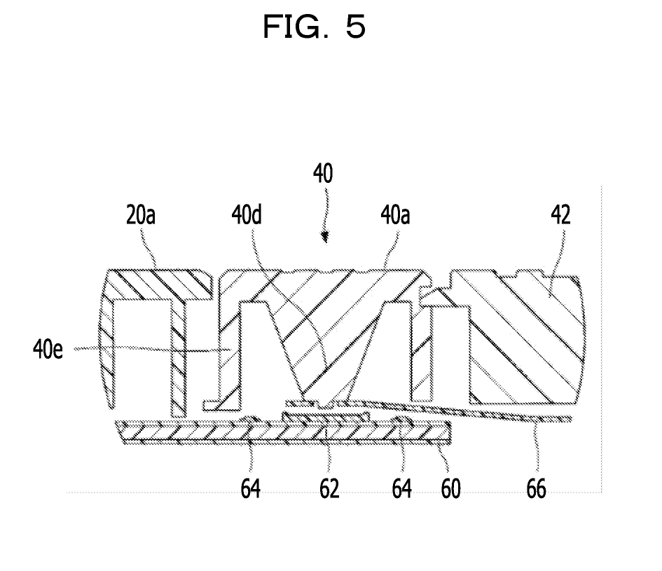

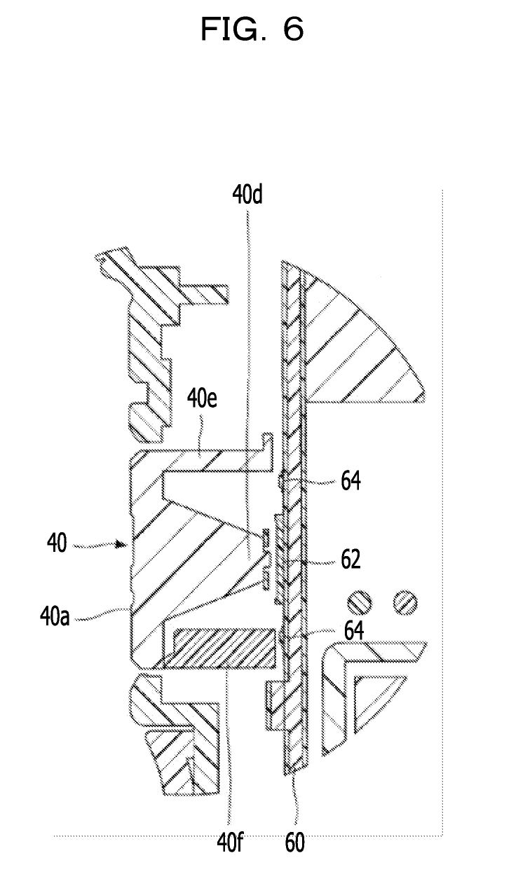

FIG. 5 is an enlarged cross-sectional view taken along the line V-V in FIG. 4. FIG. 6 is an enlarged cross-sectional view taken along the line VI-VI in FIG. 4. FIGS. 5 and 6 illustrate a state in which the power button 40 is pressed down, and the top surface 40a has approximately the same height as an upper surface 20a of the housing of the main body 20. This position of the power button 40 is the position when the notebook computer 10 is normally used (the keys are not lighted up) and corresponds to a non-lighting position.

As illustrated in FIGS. 5 and 6, the power button 40 is a cylindrical member having the top surface 40a. The power button 40 has a hollow inside, and a switch pressing part 40d, which extends downward, is formed at the central portion of an upper plate 40c which forms the top surface 40a. The switch pressing part 40d is a long pin and the periphery thereof is provided with a rib for reinforcement. In FIGS. 5 and 6, the peripheral rib is illustrated by its cross section, thus the switch pressing part 40d is illustrated as a conical portion which extends inwardly of the power button 40.

Inside the main body 20, a substrate 60 is disposed below the power button 40 and a switch 62 is mounted on the substrate 60. The switch 62 is disposed so as to be located just below the switch pressing part 40d of the power button 40. Therefore, when the top surface 40a of the power button 40 is pressed and the power button 40 is lowered, the switch pressing part 40d is lowered to press the switch 62, and thus the switch 62 is in a conductive state. When the switch 62 is in a conductive state, a power on signal is supplied to a control unit (not illustrated) of the notebook computer 10, and the power supply of the notebook computer 10 is turned on.

A plurality of LEDs 64 are disposed as light sources for lighting the icon 40b around the switch 62 on the substrate 60. When power is supplied to the notebook computer 10, the LEDs 64 consistently light up so as to irradiate the inside of the power button 40 consistently and to light up the icon 40b.

As illustrated in FIG. 5, a leaf spring 66 is provided by which the end of the switch pressing part 40d of the power button 40 is urged so as to be pressed upward. One end of the leaf spring 66 is engaged with the end portion of the switch pressing part 40d, and the other end is fixed to the housing or components of the main body 20. In the state illustrated in FIG. 5, the power button 40 is locked by the slide knob 42 and is kept away from being moved upward.

In the following, the shape of the power button 40 will be further described in detail. As illustrated in FIG. 6, part of a cylindrical side wall 40e of the power button 40 is a transparent part 40f which is composed of a transparent material. When the power button 40 is raised, the transparent part 40f appears from the upper surface 20a of the housing of the main body 20 and is located at a position facing the input operation section 26. In the above state, light from the LEDs 64 passes through the transparent part 40f and is emitted to the keys 22, 24 of the input operation section 26.

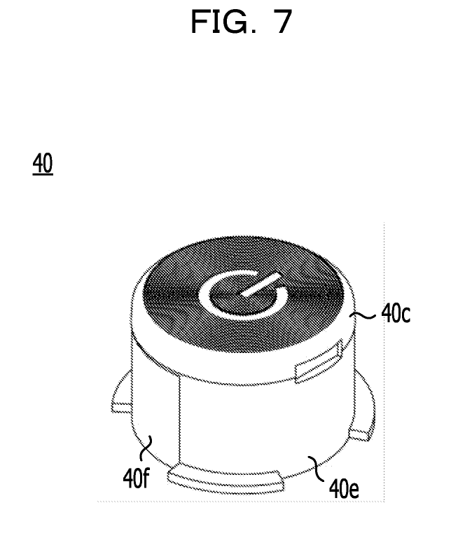

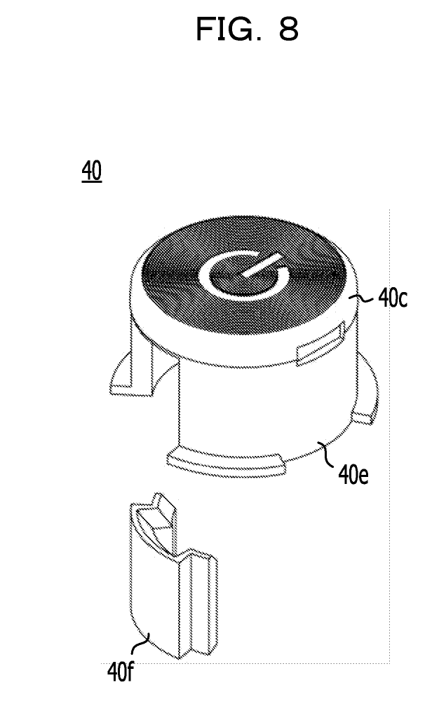

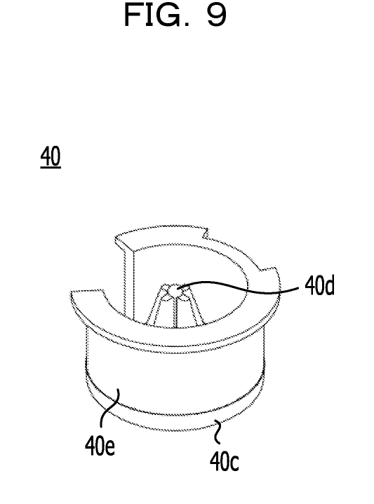

FIG. 7 is a perspective view of the power button 40. FIG. 8 is a perspective view of the power button 40 with a transparent part 40f removed. FIG. 9 is a perspective view from below of the power button 40 with the transparent part 40f removed.

As illustrated in FIG. 8, a portion of the side wall 40e of the power button 40 is cut off and the transparent part 40f is inserted into the portion. The transparent part 40f is composed of a transparent material, and light from the LEDs 64 is reflected by the inner surface of the power button 40 and is concentrated in the transparent part 40f. The light then passes through the transparent part 40f and is emitted to the outside.

The top plate 40c of the power button 40 is also composed of a transparent material, and a reflective film is provided on the top surface 40a or the face on the other side (the face inside the power button) of the top surface 40a. The above-described icon 40b corresponds to a portion where no reflective film is formed, and light from the LEDs 64 passes through the icon 40b and is emitted to the outside of the power button 40. The reflective film is, for example, a metal thin film and may be formed in the power button 40 by a method such as vapor deposition. It is preferable that the reflective film be formed in the inner surface of the side wall 40e of the power button 40 illustrated in FIG. 9.

As described above, the inner surfaces of the side wall 40e and the top plate 40c of the power button 40 each serve as a reflective surface for reflecting light from the LEDs 64. The light reflected by the reflective surfaces is concentrated in the transparent part 40f, passes through the transparent part 40f, and is emitted to the outside of the power button 40. In this manner, the inner reflective surfaces of the power button 40 and the transparent part 40f each correspond to a light projecting part for emitting light.

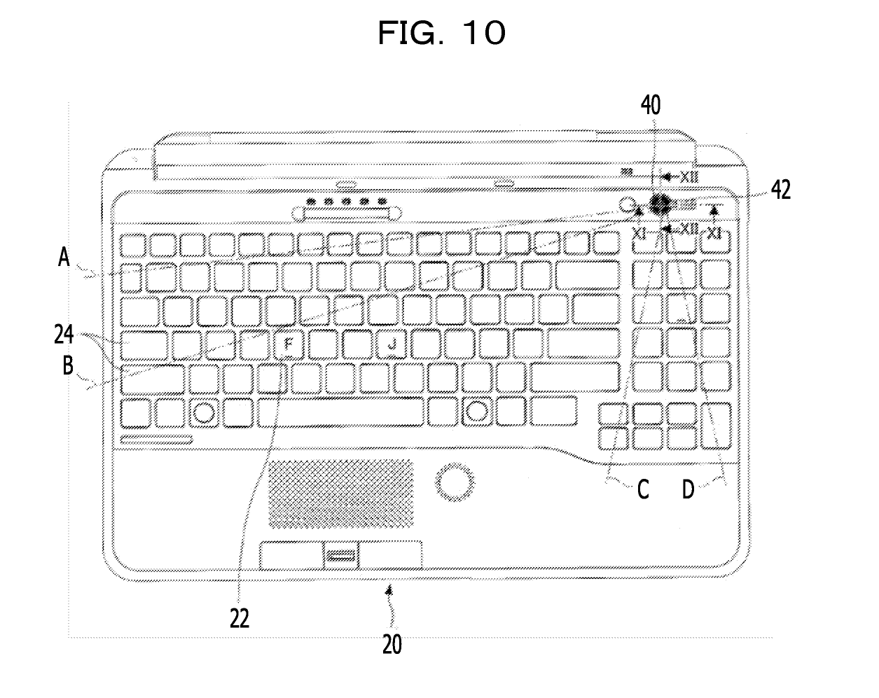

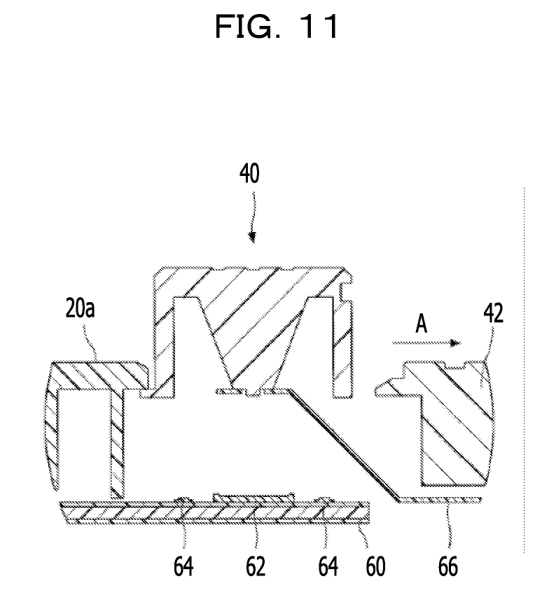

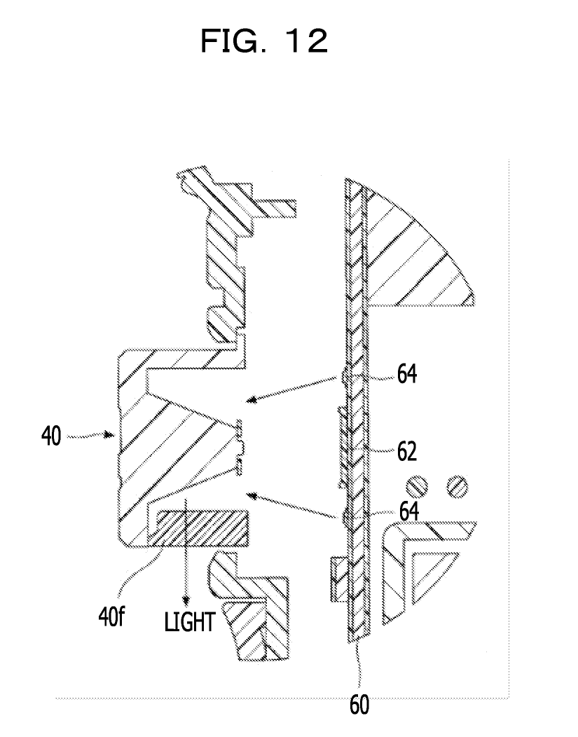

FIG. 10 is a top view of the main body 20 with the power button 40 at a raised position. FIG. 11 is an enlarged cross-sectional view taken along the line XI-XI in FIG. 10. FIG. 12 is an enlarged cross-sectional view taken along the line XII-XII in FIG. 10.

As illustrated in FIG. 11, when the slide knob 42 is moved in the direction of arrow A, engagement with the power button 40 is released. The power button 40 urged by the leaf spring 66 is then moved upward and the transparent part 40f as part of the side wall 40e appears from the upper surface of the housing of the main body 20. The LEDs 64 emit light under the inside of the power button 40, and as illustrated in FIG. 12, the light from the LEDs 64 is reflected on the inner reflective surfaces of the power button 40, passes through the transparent part 40f, and is emitted to the outside of the power button 40.

In FIG. 10, a range of light emitted from the transparent part 40f is illustrated by a two-dot chain line. The range between two-dot chain lines B and C is an area which is irradiated with the light emitted from approximately the center of the lens surface of the transparent part 40f, thus the area is bright. The range between two-dot chain lines A and B, and the range between two-dot chain lines C and D are areas which are irradiated with the light emitted from approximately the sides of the lens surface of the transparent part 40f, thus the areas are darker than the range between two-dot chain lines B and C but still are irradiated with the light through the transparent part 40f.

Approximately the entire keys of the input operation section 26 is lighted up by the light through the transparent part 40f of the power button 40, thus approximately the entire input operation section 26 may be lighted up by the existing light sources (LEDs 64) provided for the power button 40.

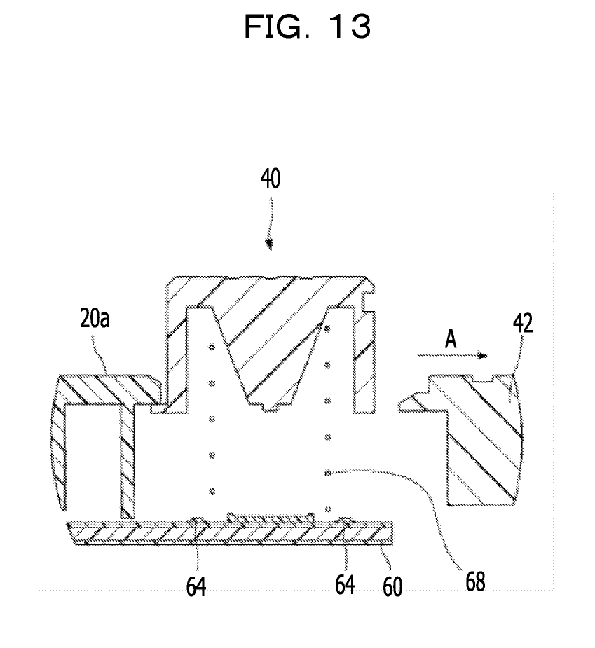

The leaf spring 66 is provided as an elastic body for urging the power button 40, however, the elastic body is not limited to the leaf spring 66 and an elastic body such as a coil spring or a rubber element may be used. FIG. 13 is a cross-sectional view in the case where a coil spring is used as an elastic body. In FIG. 13, instead of the leaf spring 66, a coil spring 68 is disposed between the power button 40 and the substrate 60 so as to urge the power button 40.

When the input operation section 26 does not have to be lighted, the power button 40 is lightly pressed down with a finger, and thus the power button 40 may be returned to the original position (corresponding to the non-lighting position illustrated in FIG. 5). When power button 40 is pressed down to a position illustrated in FIG. 5, the slide knob 42 urging the power button 40 is engaged with recesses of the side of the power button 40. Consequently, the power button 40 is held at the position illustrated in FIG. 5. When the input operation section 26 has to be lighted, the slide knob 42 is moved in a direction away from the power button 40, and thus the power button 40 is automatically raised. Thus, the power button 40 is located at a position (corresponding to a lighting position) which allows the transparent part 40f to be exposed from the housing of the main body 20, and the light from the LEDs 64 passes through the transparent part 40f and is emitted to the input operation section 26.

Combination of the leaf spring 66 for urging the power button 40 and the slide knob 42 for holding the power button 40 has been described as an example of raising and lowering mechanism of the aforementioned power button 40, however, the raising and lowering mechanism is not limited to this and other well-known mechanisms may be used. For example, the lateral surface of the power button 40 may be provided with a spiral groove and movement of the power button 40, which is rotated while being raised or lowered, is utilized, so that the power button 40 may be held at an upper or lower position. Optionally, the raising and lowering mechanism of a depression electrical switch may also be used.

As described above, according to the present embodiment, a lighting device for lighting the input operation section 26 includes the light projecting part having the inner reflective surfaces of the power button 40 and the transparent part 40f, and the LEDs 64 which are existing light sources for lighting the power button 40 from the inside. The light sources of the lighting device is the existing LEDs 64, and an additional light source does not have to be provided. The mechanism for raising the power button 40 only includes the slide knob 42 for locking the power button 40, and the leaf spring 66 or the coil spring 68 which are each an elastic body for urging the power button 40 upward. Therefore, the number of additional components for forming the lighting device is only a few and the structure of the lighting device is simple. An increase of the manufacturing cost of the notebook computer 10 for forming the lighting device is almost negligible.

The notebook computer 10 according to the present embodiment is provided with a lighting device which uses the light source of the indicators 50A to 50E in addition to the above-described lighting device which uses the light source of the power button 40.

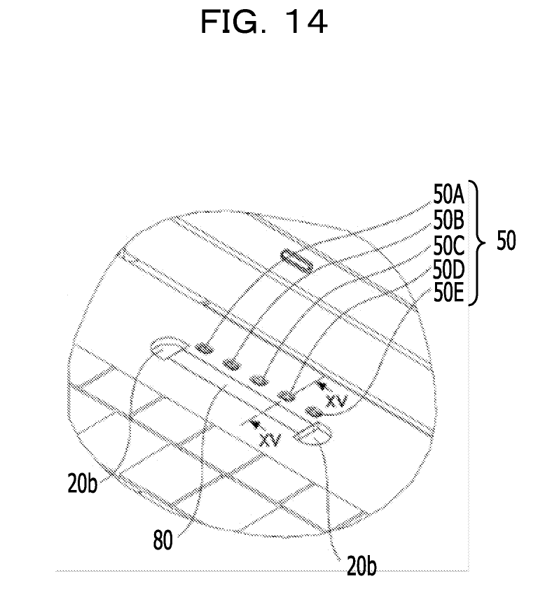

FIG. 14 is an enlarged view of portion B in FIG. 1. Each of the indicators 50A to 50E is one end of a light guiding unit 72, the one end being exposed from the housing of the main body 20. Hereinafter, the indicators 50A to 50E may be collectively referred to as an indicator 50. The light source provided in the housing of the main body 20 emits light, and thus the light is emitted from the indicator 50 and a state of function or operation of the notebook computer 10 may be displayed as ON or OFF. In the present embodiment, a reflective plate 80 is provided in the vicinity along the aligned indicator 50. As described below, the reflective plate 80 forms a light projecting part for emitting the light from the light source for the indicator 50 to the keys of the input operation section 26.

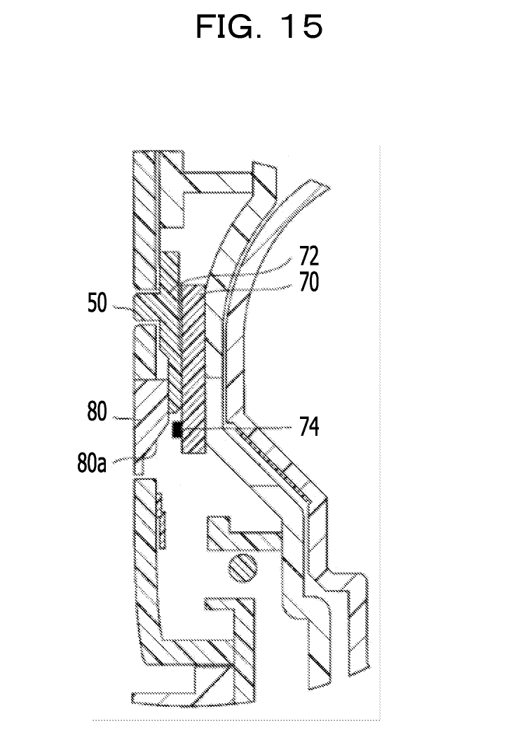

FIG. 15 is a cross-sectional view taken along the line XV-XV in FIG. 14. As illustrated in FIG. 15, the light guiding unit 72 is mounted in the substrate 70 inside the main body 20, the light guiding unit 72 having one end which forms the indicator 50. Each of LEDs 74 is disposed as a light source for the indicator 50 at a position on the substrate 70, the position facing another end of the light guiding unit 72. When the LED 74 emits light, the light passes through the light guiding unit 72 and is emitted from the indicator 50. Thus, display by the indicator 50 is performed.

The reflective plate 80 is provided above the LED 74. The reflective plate 80 is a horizontally long U-shaped member made of resin which is vertically movable above the LED 74. That is to say, when both sides of the reflective plate 80 are raised with fingers, an opening is formed between the upper surface 20a of the housing of the main body 20 and the reflective plate 80, and light from the LED 74, which is disposed below the reflective plate 80, may be emitted to the outside of the housing of the main body 20 through the opening.

The bottom of the reflective plate 80 is provided with a reflective surface 80a which is inclined at an angle of approximately 45 degrees with respect to the direction to the LED 74. The reflective surface 80a is provided in order to reflect the light from the LED 74 and to bend the traveling direction of the light for approximately 90 degrees.

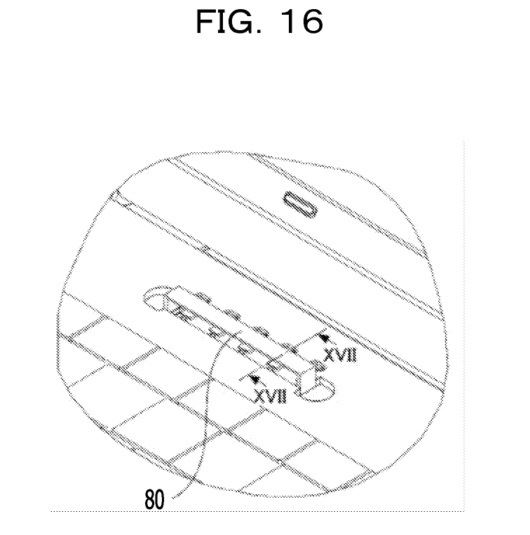

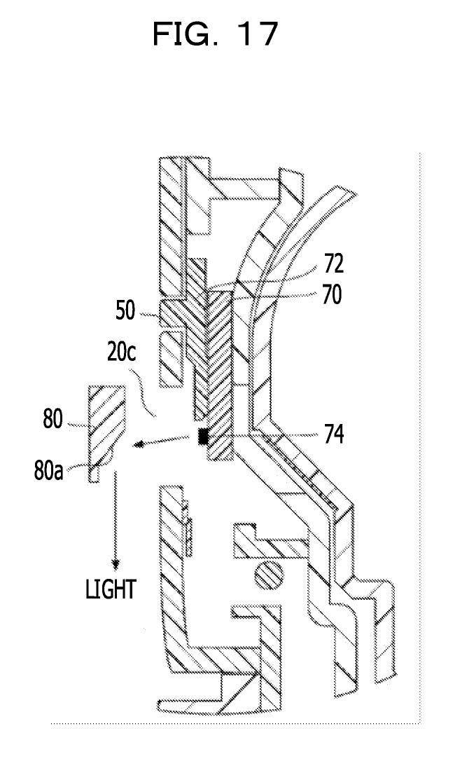

FIG. 16 is a perspective view illustrating the reflective plate 80 which is raised. FIG. 17 is a cross-sectional view taken along the line XVII-XVII in FIG. 16. When the input operation section 26 is irradiated with the light from the light source for the indicator 50, the reflective plate 80 is raised as illustrated in FIG. 16. The above operation is performed by a user of the notebook computer 10 in such a manner that the user holds and raises both ends of the reflective plate 80 in the longitudinal direction with fingers. For this operation, recesses 20b are formed on the housing near the respective ends of the reflective plate 80 in the longitudinal direction, so that the reflective plate 80 is easily held.

The sides of both ends of the U-shaped reflective plate 80 are formed so as to open outward, thus are pressed against the housing of the main body 20. Consequently, frictional force between the sides of both ends of the reflective plate 80 and the housing of the main body 20 is capable of holding the reflective plate 80 at a raised position. The raised position of the reflective plate 80 corresponds to the lighting position. When the input operation section 26 does not have to be lighted, the upper surface of the reflective plate 80 may be lightly pressed down with a finger to be returned to the original position (corresponding to the non-lighting position illustrated in FIG. 14) easily.

When the reflective plate 80 is in a raised state as illustrated in FIG. 16, the opening 20c of the housing of the main body 20 is exposed as illustrated in FIG. 17, the opening 20c being previously closed by the reflective plate 80. Thus, the light from the LED 74 located below the reflective plate 80 passes through the opening 20c, is reflected by the reflective surface 80a of the reflective plate 80, and is emitted to the keys of the input operation section 26.

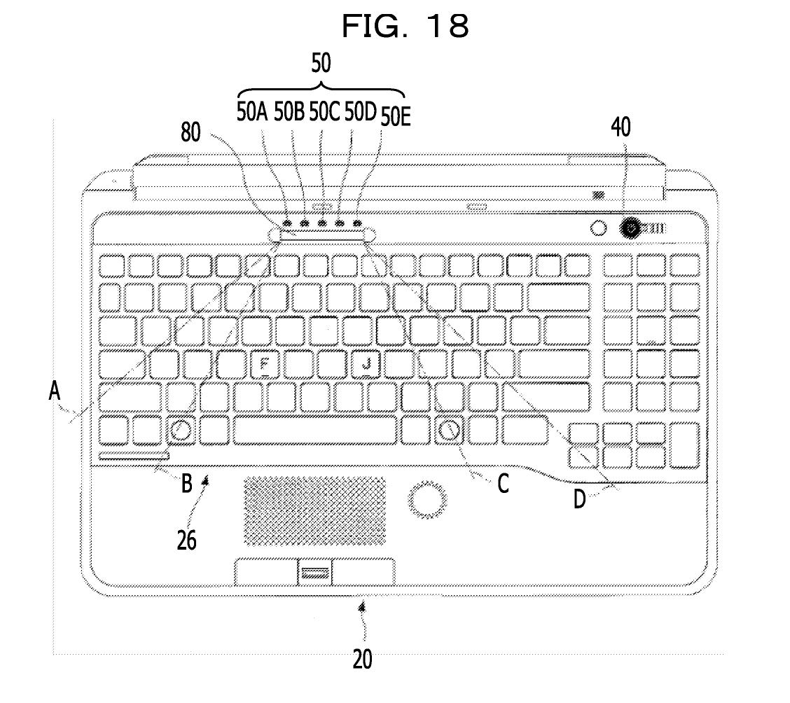

FIG. 18 is a top view of the main body 20 of the notebook computer 40, the view illustrating an irradiation range of the light projecting from the reflective plate 80. The range defined by boundary lines in directions approximately perpendicular to the longitudinal direction of the reflective plate 80, that is, the range between two-dot chain lines B and C is an area on which much of the light projecting from the reflective plate 80 impinges, thus the area is bright. The ranges on both respective sides of the above range, that is, the range between two-dot chain lines A and B, and the range between two-dot chain lines C and D are areas on which the light diffracted by both sides of the reflective plate 80 impinges, thus the areas are darker than the range between two-dot chain lines B and C but still are irradiated with the light from the reflective plate 80.

Approximately the entire keys of the input operation section 26 is lighted up by the light from the reflective plate 80, thus approximately the entire input operation section 26 may be lighted up by the existing light source (LED 74) provided for the indicator 50.

In the present embodiment, the opening 20c of the housing of the main body 20 is exposed by raising or lowering the entire reflective plate 80, however, the opening 20c may also be exposed by moving the reflective plate 80 with another method. For example, the opening 20c of the housing may be exposed by rotating the reflective plate 80 around the center of one side (the side away from the input operation section 26) of the reflective plate 80 in the longitudinal direction.

In the present embodiment, the reflective plate 80 is provided for a plurality of the LEDs 74 for a plurality (five pieces) of indicators 50A to 50E, however, the number of LEDs as the light source for one reflective plate is not limited to 5 pieces, and may be 2 to 4 pieces or 6 pieces or more.

According to the present embodiment, the lighting device for lighting the input operation section 26 includes the reflective plate 80 which has the reflective surface 80a serving as a light projecting part and may be raised or lowered, and the LED 74 which is the existing light source for emitting the reflective plane 80a. The light sources of the lighting device is the existing LEDs 74, and an additional light source does not have to be provided. In addition, the reflective plate 80 is just raised or lowered by holding with fingers, and a raising and lowering mechanism may not be particularly provided. Therefore, the number of additional components for forming the lighting device is only a few and the structure of the lighting device is simple. An increase of the manufacturing cost of the notebook computer 10 for forming the lighting device is almost negligible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A lighting device comprising:
a light source which is disposed in a vicinity of a part to be lighted and provided for a function other than lighting the part to be lighted; and
a light projecting part which is movable between a lighting position and a non-lighting position and configured to emit the light from the light source to the part to be lighted when the light projecting part is moved to the lighting position.

2. The lighting device according to claim 1,
wherein the light projecting part includes an inner surface as a reflective surface configured to reflect light from the light source in a direction different from a direction of the light.

3. The lighting device according to claim 2,
wherein the reflective surface of the light projecting part reflects the light from the light source in a direction different from a direction of the light by 90 degrees.

4. The lighting device according to claim 1,
wherein the lighting position of the light projecting part is at a position which is further away from the light source than the non-lighting position is.

5. The lighting device according to claim 4, further comprising
an elastic body configured to urge the light projecting part in a direction away from the light source.

6. The lighting device according to claim 5,
wherein the light projecting part is formed as an open bottom cylindrical member having an upper surface, the light source is disposed on a bottom side, and an inner surface of the light projecting part serves as the reflective surface.

7. The lighting device according to claim 6,
wherein part of a side wall of the cylindrical member is provided with a transparent part which is composed of a transparent material, and light reflected by the reflective surface of the cylindrical member passes through the transparent part and is emitted to an outside of the cylindrical member.

8. The lighting device according to claim 5, further comprising
a holding member which is movable in a direction perpendicular to a moving direction of the cylindrical member and configured to be engaged with the cylindrical member and to inhibit movement of the cylindrical member.

9. The lighting device according to claim 5,
wherein the light projecting part is a member having a planar face which faces the light source.

10. The lighting device according to claim 9,
wherein the planar face has an inclined face which is inclined with respect to a direction to the light source and the inclined face serves as the reflective surface.

11. The lighting device according to claim 9,
wherein a plurality of light sources including the light source are disposed to face the light projecting part.

12. An electronic device comprising:
a lighting device includes
a light source which is disposed in a vicinity of a part to be lighted and provided for a function other than lighting the part to be lighted, and
a light projecting part which is movable between a lighting position and a non-lighting position and configured to emit the light from the light source to the part to be lighted when the light projecting part is moved to the lighting position; and
an input operation portion that is lighted by light from the lighting device.

13. The electronic device according to claim 12,
wherein the light source is used as a light source for displaying a function of the electronic device in addition to be used as a light source of the lighting device.

14. The electronic device according to claim 12,
wherein the non-lighting position of the light projecting part is a position at which the light projecting part is housed in a housing of a main body of the electronic device, and
the lighting position is a position at which the light projecting part projects from the housing.
